(19) United States
(12) Patent Application Publication
(10) Pub. No.: US 2007/0008622 A1
(43) Pub. Date: Jan. 11, 2007

(54) Water viewing device and method for alternating depth perspectives

(76) Inventor: Christopher W. Sommer, Phoenix, AZ (US)

Correspondence Address: Christopher W. Sommer, 5933 E. Calle Del Paisano, Phoenix, AZ, 85018, US

(21) Appl. No.: 11/201,481

(22) Filed: Aug. 11, 2005

Related U.S. Application Data
(60) Provisional application No. 60/601,107, filed on Aug. 12, 2004.

(51) Int. Cl. G02B 27/22

(52) U.S. Cl. 359/466

(57) ABSTRACT

The present invention is a device and method of using the device to view objects that are on or under the surface of water by alternating depth perspective views. The inventive device includes a container, and a mirror device within the container, with each side preferably having a different reflective surface. The mirror device is able to be rotated or adjusted via a handle.

### FIELD OF THE INVENTION

The present invention relates generally to containers with mirrors and more specifically it relates to a device for viewing objects, from underneath, that are on or under the surface of water, with a method of alternating depth perspective views of close up, such as several inches or closer, to a simulated view of farther away, such as several feet.

### BACKGROUND OF THE INVENTION

It can be appreciated that containers with mirrors have been in use for years. Typically, containers with mirrors are aquariums or other transparent or clear containers that can hold water. Some of these products use reflective surfaces on the bottom or sides of the container, which provide reflection perspectives of objects in the container. For example, U.S. Pat. Nos. 3,706,299 and 3,908,598 are aquariums that utilize reflective surfaces to offer multiple perspectives of objects inside the aquarium. Another example is U.S. Pat. Application No. 2003/0066837, which is a cup that “comprises a reflection layer . . . at the bottom of the cup . . . ”.

While these devices may be suitable for the particular purpose to which they address, the main problem is that existing products do not provide a method or means for a user to view an object from more than one perceived distance. For example, a user cannot easily view the underside of an object on or under the surface of water from a perspective of close up, and then change the perspective to simulate a viewing of the object from several feet away without physically moving several feet away from the container. Another problem with conventional containers with mirrors are that the angle of reflective surfaces inside the containers cannot be adjusted based on user orientation or viewing angle without the user reaching into the container and making physical contact with the reflective surface, or altering the angle of the whole container.

In these respects, a water viewing device and method for alternating depth perspectives according to the present invention substantially departs from the conventional concepts and designs of the prior art, and in so doing provides an apparatus primarily developed for the purpose of viewing objects, from underneath, that are on or under the surface of water, with a method of alternating depth perspective views of close up, such as several inches or closer, to a simulated view of farther away, such as several feet.

### SUMMARY OF THE INVENTION

A device to view from underneath, objects, such as a real or imitation fly, that are on or under the surface of water, with a method of alternating depth perspective views of close up, such as several inches or closer, to a simulated view of farther away, such as several feet. The inventive device includes a clear, transparent plastic container, and a two sided mirror device within the container, with each side having a different reflective surface, such as flat, convex, or concave. The mirror device is able to be rotated or adjusted via a handle, which protrudes through a container wall.

In view of the foregoing disadvantages inherent in the known types of containers with mirrors now present in the prior art, the present invention provides a new water viewing device and method for alternating depth perspectives construction wherein the same can be utilized for viewing objects, from underneath, that are on or under the surface of water, with a method of alternating depth perspective views of close up, such as several inches or closer, to a simulated view of farther away, such as several feet.

The general purpose of the present invention, which will be described subsequently in greater detail, is to provide a new water viewing device and method for alternating depth perspectives that has many of the advantages of the containers with mirrors mentioned heretofore and many novel features that result in a new water viewing device and method for alternating depth perspectives which is not anticipated, rendered obvious, suggested, or even implied by any of the prior art containers with mirrors, either alone or in any combination thereof.

To attain this, the present invention generally comprises the following: A clear, transparent plastic container, with a lid, and 2 grommets inserted into opposing walls of the container. A two sided device, with each side having a different reflective surface, such as flat, convex, or concave, and a handle that inserts through a grommet in the container wall into the Mirror Device.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

In accordance with an exemplary embodiment of the present invention, it will ideally provide a water viewing device and method for alternating depth perspectives that will overcome the shortcomings of the prior art devices.

A representative embodiment of the present invention may provide a water viewing device and method for alternating depth perspectives for viewing objects, from underneath, that are on or under the surface of water, with a method of alternating depth perspective views of close up, such as several inches or closer, to a simulated view of farther away, such as several feet.

Another representative embodiment of the present invention may provide a water viewing device and method for alternating depth perspectives that allows a user to place an object, such as a live or imitation insect, on or under the surface of the water in the container, and easily view the underside of that object from a perspective of close up and conversely several feet away without moving them self, the object, or the container in which the object is held.

Another representative embodiment of the present invention may provide a water viewing device and method for alternating depth perspectives that allows a user to quickly, easily, and continuously adjust the selection and angle of the reflective surfaces submerged in the water without touching the water or the reflective surfaces. In addition, the invention may be able to hold water and resist leaking near the handle/axis or spilling out the top when used, handled, or transported.

Other embodiments and advantages of the present invention will become obvious to the reader and it is intended that these embodiments and advantages are within the scope of the present invention.

To the accomplishment of the above and description of alternate embodiments, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Other representative embodiments, features and attendant advantages of the present invention may become fully appreciated as the same becomes better understood when considered in conjunction with the accompanying drawings, in which like reference characters designate the same or similar parts throughout the several views, and wherein:

FIG. 1 is a perspective view of the present invention

FIG. 2 is a top view of the inner layer of the Mirror Device

FIG. 3 is a side view of the Handle and Pin

FIG. 4 is a side view of Alternate Mirror Device.

### DETAILED DESCRIPTION OF THE PREFERRED EMBODIMENTS

Turning now descriptively to the drawings, in which similar reference characters denote similar elements throughout the several views, the attached figures illustrate a water viewing device and method for alternating depth perspectives, which comprises the following: A clear, transparent plastic container 1, with a lid 2, and two grommets 3 inserted into opposing walls of the container. A two sided Mirror Device 12, with each side having a different reflective surface, such as flat 11, convex 10, or concave 31, and a handle/pin (handle 20 and pin 21 comprise the handle/pin) that inserts through a grommet 3 in the container wall into the Mirror Device.

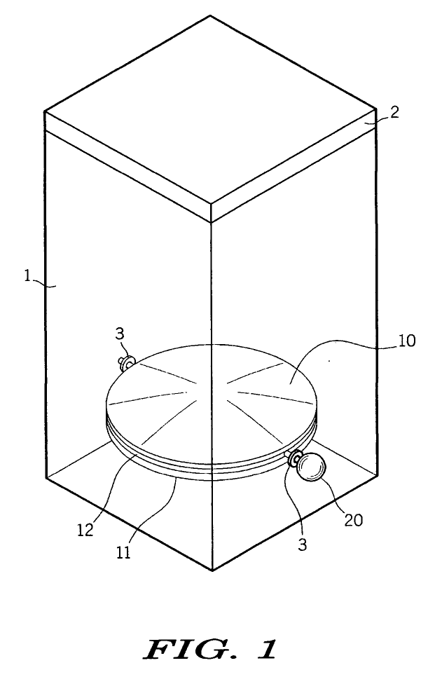

As shown in FIG. 1 of the drawings, the container 1 may be made of clear plastic, and may have a lid 2 that fits snugly on the opening at the top of the container 1. The ideal design of the container 1 will offer at least one clear, flat surface for the front viewing area so the objects inside are as clearly presented as possible, although a non-flat surface could also be used. When constructing the present invention, two holes may be drilled or manufactured into opposing sides of the container near the bottom, into which the grommets 3 may be inserted to be used in conjunction with the Mirror Device 12 as described in the next paragraph. The holes, and thus the grommets 3, should ideally be centered on opposing container walls, and positioned as close to the container bottom as possible without impeding the 360 degree rotation of the Mirror Device 12. Therefore, the holes will likely be positioned slightly farther from the container bottom than the length of the Mirror Device's 12 radius. The grommets 3 may be rubber, or any other material known in the art that forms a leak resistant seal between the handle axis and axis pin, which passes through the grommets 3, and the container 1 walls. Ideally rubber grommets are inserted into the holes in the opposite sides of the container, and have a lubricant applied to the grommet surfaces to a) allow for easy insertion, and b) to help form a leak proof seal with the handle pin 21.

The Mirror Device 12, comprised of plastic, rust-proof metal, or other material, would ideally have two or more different reflective surfaces, such as a flat mirrored surface 11 and convex mirrored surface 10. The Mirror Device 12 would also ideally offer a nub 13 on its side, which would fit into a grommet 3, opposite a slot 14, in which the handle's pin 21 would be inserted. The handle 20 will ideally be comprised of the same material as the Mirror Device 12, but could be another material. The handle 20 will also have protruding from it a thin, rod or pin 21, which would be inserted through the grommet 3 in one wall of the container 1 into the mirror Device 12. The pin 21 will also ideally be comprised of the same material as the Mirror Device 12, and would be secured into the Mirror Device 12 via an engineered design, a tight fit within the Mirror Device slot 14, and/or may have glue, epoxy, or other affixing material added for strength and stability.

It should be appreciated that variations of the present invention and container 1 could be numerous. The container 1 may be in different shapes, such as square, round, spherical, rectangular, elongated, etc., and be comprised of many different materials, such as plastic, glass, or other common materials, transparent, opaque or otherwise. The entire container 1 need not be clear or transparent, but it should ideally have at least one clear surface for viewing of objects in or above the container. The viewing surface would ideally be flat, but could be rounded, lenticular, convex, concave, or otherwise not flat. The container 1 may also be created in any size depth, width, or height. Some variations of the present invention may be long or wide enough to allow a user to look through the water surface onto the reflective surfaces and back up to the items in the container, rather than looking through a container wall.

Another representative embodiment could have different mirrors located side by side at angles for viewing, rather than back to back, on the container 1 bottom. In that case they could be placed at an angle ideal for viewing objects in or above the container, or they could be placed flat on the bottom, which in either case may obviate the need for a handle and/or axis. The angle of reflective surfaces could be at the same angle or different angles. Another variation could be a container with two or more different mirrors, such as flat, convex, or concave, that are adhered back to back, but not on a rotate-able axis, placed, but not adhered, at an angle at the container's 1 bottom. In the prior representative embodiments the mirror would ideally be set at an angle ideal for viewing of objects in or above the container, and the user would likely need to manually adjust the mirrors to obtain the desired side/perspective, and angle.

Alternate variations of using grommets 3 for a leak resistant handle pin 21 include other materials that are applied to the holes in the container walls so when the handle pin 21 is inserted through a hole in the container 1 wall a leak resistant seal is realized. Materials that achieve this affect could include grommets, stickers, tape, or strip or bit of materials such as latex, rubber, adhesive tape, glue, or caulk.

A variation of the container 1 could allow a movement or flow of water into the container, and possible out of the container 1, so the user could view the objects in the water or on the surface in moving water. Another embodiment would contain a light source that illuminates from within or without, objects in or out of the container 1. Another alternate method of construction would be to have only one hole in the container 1, with one grommet 3. The handle pin 21 could go through that grommet 3 into the mirror Device 12, while the opposite site of the mirror Device 12, probably via a nub 13 on the mirror device or on the container wall, could fit into a crevice or slot on the container wall or mirror device, obviating the need for a second hole and grommet 3. Another variation of the present embodiment could place mirrors or reflective surfaces under or otherwise outside the container, which could be used to view objects in the container.

It should be appreciated that variations of the present invention and mirror device could be numerous. The Mirror Device 12 could be built in any size, smaller or larger, and the Mirror Device 12 could also be different shape, such as square or rectangular. As shown in FIG. 4, a Mirror Device 30, as an alternate for mirror Device 12, could be constructed to have three or more reflective surfaces, including flat 11, convex 10, concave 31, or alternate finishes, such as brushed, colored, tinted, etc. This device 30 could utilize a similar handle pin 21 to act as an axis, which is inserted into the device center axis point 32. The mirrors could be individual mirrors that are adhered together on an inner layer/device, or, as is ideal, they could be manufactured as one or more pieces of material with chromed or polished reflective surfaces that are more easily assembled. An alternate mirror device may have a handle pin 21 or spindle entering the container from the bottom, top, or sides.

Alternate methods to allow turning of the mirror device include using one or more magnets or magnetic attractants, such as metal, attached to the mirror device, so the user could turn the device using a separate magnet or magnetic attractant on the outside of the container. Another alternate method of turning the mirror device may include other manual ways of physically contacting the Mirror Device 12 within the container, such as a stick, handle, production of bubbles, water flow, counter weight, etc.

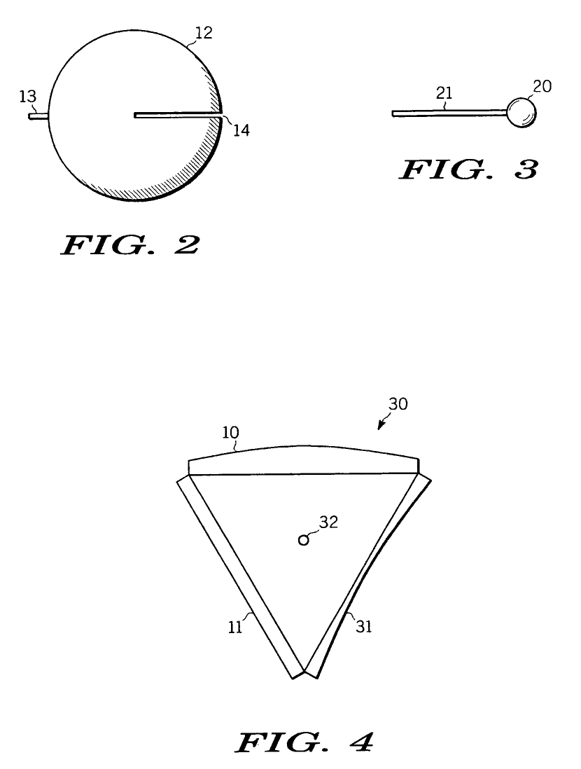

Regarding connections of aspects or parts of the invention and related manufacture and assembly shown in FIGS. 1-4: a. If holes for grommets 3 are not manufactured into opposite sides of the container they might need to be created, perhaps using a drill and bit. b. Grommets 3 would be inserted into these 2 holes, probably using a lubricant for ease of insertion and to help form a leak resistant seal. c. The mirror Device 12 may be manufactured as a single unit. Alternatively the device could be manufactured by adhering two mirrors 10 and 11 back to back, with an insert or adhesive layer in between them. d. The Mirror Device 12 will be placed into the container 1, first inserting the nub 13 into a grommet 3, then aligning the slot 14 with the grommet hole opposite that occupied by the nub 13. e. The handle pin 21 will be inserted through the grommet 3 opposite that occupied by the nub 13, into the slot 14. Alternate mirror device 30 could interconnect with the container in basically the same as described for the proposed device, using an axis and handle, etc., or it could interact in various ways.

Ideally, to use the invention, a user would remove the container lid 2 and nearly fill the container 1 with water, although the user could adjust the amount of water in the container to adjust the perspective distances. The user could then place an object, such as a real or imitation insect, on or under the water surface, and optionally put the lid 2 on the container. Optionally, a user could suspend or hold an object over the mirror device without water in the container. Next, the user could place the container 1 on a flat surface or table, or could hold it instead. Then the user could, using the handle 20, adjust the mirror device 12 to the type of mirror (flat, convex, etc.) and angle they desire for proper viewing of the underside of the object. The user could continuously switch back and forth between alternate mirror perspectives and angles by adjusting the handle 20. Although not adjusted by the user, the grommets 3 will provide a leak resistant seal between the handle axis 21 and the container 1, and the lid 2 will offer a general spill resistance.

It should be appreciated that other uses for the present invention are numerous. Alternate uses of the invention may include filling it with water from an outdoor site, such as lake or river, and/or using it in various light conditions. For example, a fisherman could take the present invention to a fishing area, fill it with water from the body of water he or she will fish so the view of the object in the water, such as a real or imitation insect, is representative to the fisherman as it may be to a fish in that body of water. Similarly, the present invention could be used in various lighting conditions to simulate the lighting a fish may perceive. Users of the present invention are not limited to fisherman. For example, artificial fly tiers, students, researchers, or anyone could use the present invention in a classroom, in nature, or just about any setting, to examine objects in or above the container, with or without water. It should also be noted that the present invention could be filled with liquid other than water to properly simulate specific conditions or view objects in various ways. Another use of the present invention could be to photograph objects inside the container 1, on or under the surface of water or other liquid, or objects suspended or held above the reflective surfaces (ex. 10, 11), with or without water in the container 1. In any case, users could put one or many objects in the container, with or without water or other liquid, and view, photograph, study, or display those objects. The user could apply different lighting, lid colors, bubbles, water flow, etc. to impact the perspective of objects in the container. Another use of the present invention is to partially submerge it, bottom first, into water. The user could then look down into the container 1 and view objects in the external body of water, like a reverse periscope of sorts. Applications and uses of the present invention may even extend into other areas of industry or science where a method of viewing objects from multiple distance perspectives is useful.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious, and all equivalent relationships to those illustrated in the drawings and described in the specification are intended to be encompassed by the present invention.

Therefore, the foregoing is considered as illustrative only of the principles of the invention. Further, since numerous modifications and changes will readily occur, it is not desired to limit the invention to the exact construction and operation shown and described, and accordingly, all suitable modifications and equivalents may be resorted to, falling within the scope of the invention.

I claim:

1. A device for viewing objects that are in water comprising:
a. a housing;
b. an adjustable mirror located near one end of the housing; and
c. at least one fastener for attaching the adjustable mirror to the housing to view an object in water.

2. A device according to claim 1 comprising a light source.

3. A device according to claim 1 wherein the housing is a box shaped container.

4. A device according to claim 1 wherein the housing is a round, cylindrical shaped container.

5. A device according to claim 1 wherein the mirror is a flat, convex or concave mirror.

6. A device according to claim 1 wherein the mirror is fastened on an axel held by at least one grommet to the end of the housing and is movable around the axel.

7. A device according to claim 1 wherein the mirror is located within the housing.

8. A device according to claim 1 wherein water is present in the housing and surrounds the mirror.

9. A device according to claim 1 wherein more than one mirror is present, which are movable around the axel.

10. A method of using a device to view objects in water comprising:
a. obtaining a device comprising a housing and an adjustable mirror attached to one end of the housing; and
b. adjusting the mirror to a desirable angle to view a side of an object located in water near the housing;

11. A method according to claim 8 wherein the device further comprises a light source.

12. A method according to claim 8 wherein the device further comprises a housing which is a box shaped container.

13. A method according to claim 8 wherein the device further comprises a housing which is a round, cylindrical shaped container.

14. A method according to claim 8 wherein the device further comprises a mirror which is a flat, convex or concave mirror.

15. A method according to claim 8 wherein the device further comprises a mirror fastened on an axel held by at least one grommet to the end of the housing and is movable around the axel.

16. A method according to claim 8 wherein the device further comprises a mirror located within the housing.

17. A method according to claim 8 wherein the device further comprises water present in the housing which will surround the mirror.

18. A method according to claim 8 wherein the device further comprises more than one mirror which is movable around the axel.

19. A device to view objects in water comprising:
a. a transparent housing;
b. an adjustable mirror device, with a flat and convex mirror on opposite sides, which may be adjusted to a desirable angle to view an underside of an object located in water near the housing;
c. a handle that attaches to the mirror device through a grommet in the container wall; and
d. a lid
